(19) United States
(12) Patent Application Publication
(10) Pub. No.: US 2004/0039558 A1
(43) Pub. Date: Feb. 26, 2004

(54) System and method for modeling output characteristics of a non-linear device in conjunction with interconnect impedances

(75) Inventor: Xiaoning Qi, Sunnyvale, CA (US)

Correspondence Address: David B. Ritchie, Thelen Reid & Priest LLP, P. O. Box 640640, San Jose, CA, 95164-0640, US

(73) Assignee: Sun Microsystems, Inc.

(21) Appl. No.: 10/224,981

(22) Filed: Aug. 20, 2002

(51) Int. Cl. G06F 17/50

(52) U.S. Cl. 703/14

(57) ABSTRACT

An aspect of the current invention is directed to a method for modeling behavior of a non-linear component with a first interconnect line in a system of a plurality of interconnect lines. The method contemplates modeling an interconnect lines as a plurality of segments. Each of the segments of the interconnect line are coupled together to form the interconnect line. A non-linear component is modeled as coupled to a line segment. The line segment has an electric coupling to the other line segments, possibly on different interconnect lines. A signal associated with the first interconnect line is precharacterized. The signal is indicative of the output of the non-linear component on the line segment. The signal is then input into a linearized simulation of the system of interconnect lines.

### FIELD OF THE INVENTION

The invention relates to simulation and design of circuitry. More particularly, it relates to a system and method of simulating or modeling complex non-linear systems in a software environment.

### BACKGROUND

In many typical circuits, a non-linear device may be used to drive a signal over an interconnection. In computer systems, many of these drivers may be used to drive, or not drive, several lines concurrently. More specifically, this typically happens in a bus, where the various lines may be asserted or deasserted based on the data being transmitted.

However, when the switching times are very FAST, and the pulse being driven on the specific line is relatively short in time, the impedance of the system may substantially alter the waveform on the line relative to what was intended from the design of the system with a lower frequency switching time.

In particular, the impedance of a component is based upon the frequency. The impedance of a particular component is found from the equation:

Z=R+jωL,

where R is the resistive element, L is the inductive element, and ω is the frequency of the system. Thus, at high switching speeds, an inductance in a system may be very significant in the determination of the signal.

In a typical bus situation, many drivers are located in proximity to the drivers of other line. Additionally, the other interconnects associated with each of the other drivers are also located in close proximity to one another. The interconnects do not necessarily have a pure resistive characteristic, but exhibit resistive, capacitive, and inductive characteristics. Moreover, the proximity of the interconnects leads to various mutual capacitance terms, as well as mutual inductance terms when determining the appropriate signal in a model.

As the numbers of related interconnects grows, the complexity of the solution of the system in a non-linearized model expands dramatically. For example, with four interconnects, each interconnect line must deal with three other mutual capacitance and/or mutual inductance terms in order to determine a meaningful solution. The time to simulate a multi-line bus system with interconnects and drivers using a SPICE circuit solution can take hundreds of hours for the solution.

Some circuit simulation models linearize the entire group of driver-interconnect pairs. This linearization typically allows for a time saving in deriving the solution to the expected signal. However, in this environment, the linearized behavior of the non-linear driver in conjunction with a linear system of representing the interconnects may not achieve the highest accuracy when compared to a real implementation, or, for that matter, other non-linear model solutions.

### SUMMARY OF THE INVENTION

An aspect of the current invention is directed to a method for modeling behavior of a non-linear component with a first interconnect line in a system of a plurality of interconnect lines. The method contemplates modeling interconnect lines as a plurality of segments. Each of the segments of the interconnect line are coupled together to form the interconnect line. A non-linear component is modeled as coupled to a line segment. The line segment has an electric coupling to the other line segments, possibly on different interconnect lines. A signal associated with the first interconnect line is precharacterized. The signal is indicative of the output of the non-linear component on the line segment. The signal is then input into a linearized simulation of the system of interconnect lines.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a system for modeling a non-linear system in an interconnect system, according to the invention.

FIG. 2 is element level diagram of how the full model of the interconnect system of FIG. 1 may be envisioned.

FIG. 3 is a pictorial diagram detailing one or more steps depicted in FIG. 1.

FIG. 4 is another diagram depicting another precharacterization model using a number of the segments.

FIG. 5 is a diagram of an exemplary linearization technique of FIG. 1.

FIG. 6 is a block diagram linking the reduced order interconnect model to the linearized precharacterization signal.

FIG. 7 is a flow chart detailing a method by which the apparatus of FIG. 1 may operate.

### DETAILED DESCRIPTION

Embodiments of the present invention are described herein in the context of a System and Method for Modeling Output Characteristics of a Non-Linear Device. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

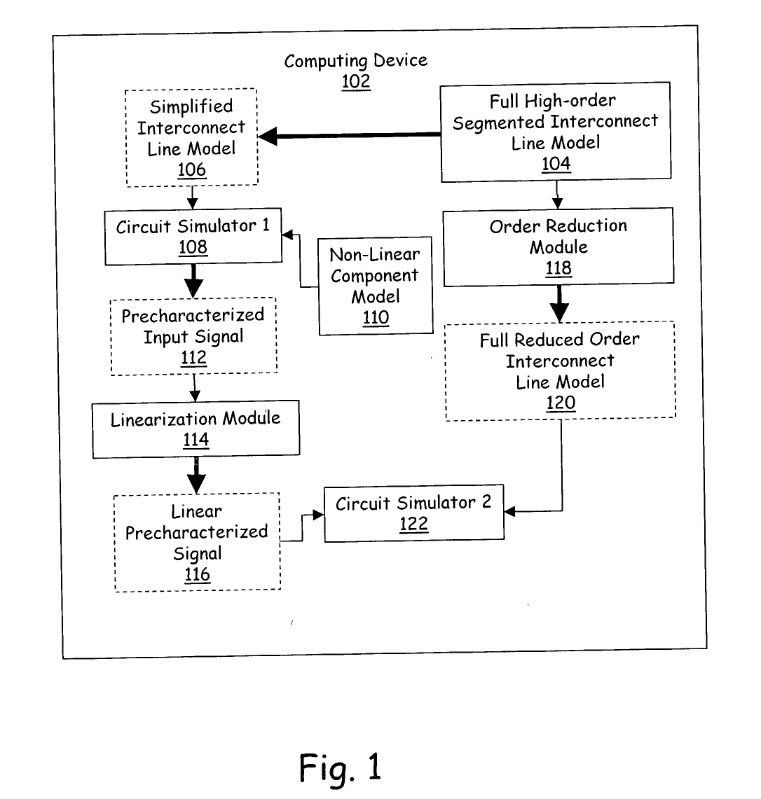

FIG. 1 is a block diagram of a system for modeling a non-linear system in an interconnect system, according to the invention. A computing device 102 contains one or more modules that enable a relatively quick and accurate signal representation of the non-linear drivers coupled to interconnect lines.

First, an interconnect system with one or more interconnect lines is modeled in a model 104. In this model 104, each interconnect line is modeled as several segments, each with its own impedance, coupled together to form the single interconnect line. Further, each of the segments is electrically cross-coupled through an impedance term to other segments in other lines. In this manner, the interconnect system has interlinked segments forming the interconnect lines. However, in addition, each line segment interacts electrically with other remote line segments, and these relationships are captured through cross impedance terms between segments in other interconnect lines. As such, this model gives rise to a high order signal solution as the characteristic transfer function of the interconnect system.

A precharacterization of the non-linear component is then approximated. For this precharacterization, the model 104 is parsed down to a simplified model 106. In one case, segments for each line and their impedances are represented in the simplified model 106. Additionally, the cross coupling between the segments through the cross impedance terms is maintained between the various lines and line segments.

It should be noted that in one embodiment, one segment of each line is used. In other cases, more than one segment may be used in this simplified model, as long as the full number of segments making up the particular line is not used. Of course, the segment of the particular line may be replaced with two or more conjoined line segments that represent the interconnect line coupled to the driver. Each of the mutual impedance terms between the line segments on other interconnect lines are maintained in the simplified model. In any case, the full model is parsed to a lower order solution employing the fewer segments, or some combination of the segments.

A circuit simulator 108 then uses the simplified segmented interconnect line model 106 and a non linear component model 110 to derive a precharacterized input signal for the interconnect line. This circuit simulator can be any of a number of circuit simulators, and should model accurately the functionality of the non-linear driver.

This methodology may be repeated for all the interconnect lines and all values of the drivers associated with each interconnect line. Thus, an initial precharacterized input signal 112 is derived for the specific interconnect, and can be derived for all the interconnects.

The precharacterized input signal 112 is put into a linearization module 114. The result is a linear precharacterized signal 116. In this manner, a linear version of the signal produced by a non-linear driver on an interconnect line is derived. Again, this may occur for each interconnect line in the interconnect system, and for each state of the associated drivers in the system.

The full interconnect model 104 is input into an order reduction module 118. This results in a reduced order interconnect model 120 of the full segmented system, including any mutual impedances between the interconnect lines.

A circuit simulator 122 is then run, using, as inputs, the linear precharacterized signal 116, and the reduced order interconnect model 120 of the full segmented system. This circuit simulator can be one of a number of simulators, and is preferably a linear circuit simulator. This allows the solution to the interconnect system to be derived faster than the solution using the circuit simulator 108. The result is a signal indicative of the interconnect system being driven by the non-linear component, the non-linear component represented by the precharacterized signal.

In this example, any of the various modules or simulators may be a single stand-alone program. The modules may exist in any combination within any other program. The modules may be executables, or may be implemented in an interpreted language. The modules may be executed on any type processor, including a virtual machine, like that found in a run-time virtual machine. Likewise, the models may exist as data files, as part of a data file, as an executable program, a persistent object, or anything of the like. The computing device may be a single computing device, or several computing devices linked by a network or through the exchange of computer readable media. In this manner, the models, modules, outputs, or simulators may exist together on a single computing device, separately or in any combination over any number of linked computing devices. The circuit simulators 108 and 122 may be separate from one another, or they may be embodied in the same simulator. In one embodiment, the circuit simulators 108 and 122 are SPICE simulators. In another, the circuit simulator 108 is a SPICE simulator, and the circuit simulator 122 is a PRIMA simulator.

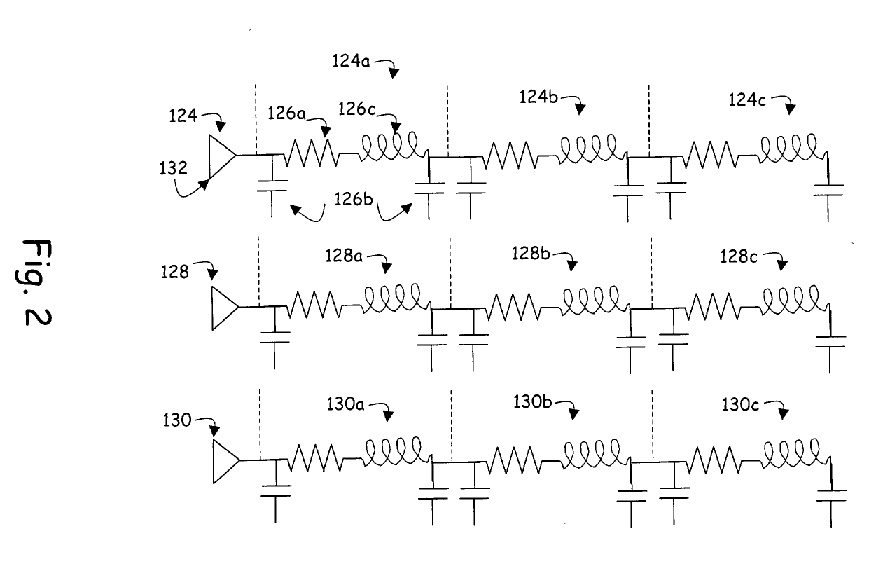

FIG. 2 is element level diagram of how the full model of the interconnect system of FIG. 1 may be envisioned. In a typical situation involving a bus, several different lines are coupled to drivers. In an aspect of the invention, the lines are modeled as interconnected segments. For example, an interconnect line 124 is broken into several different segments, such as a line segment 124a, a line segment 124b, and so on.

Each line segment has an impedance characteristic deternined, based on the present conditions. For example, the impedance characteristic of the line 124a segment is depicted having a resistive component 126a, one or more capacitive components 126b, and an inductive component 126c.

In addition, each of the other lines in the system is broken into corresponding segments. For example, the interconnect line 128 is broken into similar segments, and likewise for the rest of the interconnect lines. In this manner, each of the interconnect lines are now viewed as a coupled series of segments, each segment with their own impedance.

The representations of the line segments are then modeled on an interrelated basis. For example, in the typical situation, a single cross impedance including any/or mutual inductance, is also determined on a line segment to line segment basis. In particular, the line segment 124a will have a mutual capacitance and/or mutual inductance with the line segment 128a, the line segment 130a. This relationship may be extended to all other interconnect lines, and all combinations of interconnect lines, ad infinitum. In this FIG. 2, these other cross impedances are not depicted.

Additionally, the line segment representation can have cross impedance characteristics aside from those shown. In this manner, the line segment 124a can have cross impedance characteristics with the line segment 124b, the line segment 124c, and others down the same line. Further, the line segment 124a can have cross impedance relationships with the line segment 128b, the line segment 128c, the line segment 130b, and so on. As can be seen, the implementation of a solution to the system becomes very complicated very quickly based upon these interrelationships. This is due to the multiple order solution imposed by the various cross impedances and the coupled impedances between the lines and the associated line segments.

Additionally, assume that a line driver 132, driving the line 124, is a non-linear device. In this manner, the initial pulse and resultant signal on the line 124 may not be modeled accurately for the system defined by the line segments alone. Moreover, the solution for the particular line driver in the system based on a typical circuit solution program, such as SPICE, can take a great deal of time in this high order environment.

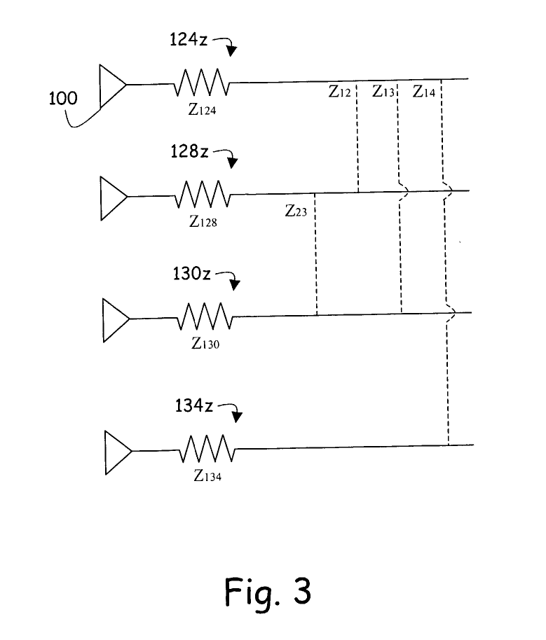

FIG. 3 is a pictorial diagram detailing one or more steps depicted in FIG. 1. In this implementation, the interconnect system is evaluated using a driver precharacterization.

The precharacterization is effectuated using fewer segments and the electrical relationships between them as defined in the full model. In one case, each line is made up of one segment.

For example, the model used in the precharacterization of FIG. 3 uses only one segment from each of the interconnects of the system of FIG. 2 to model each wire. The line segment 124z has an impedance Z₁₂₄, derived from the electrical characteristics depicted for the interconnect line 124 in FIG. 2. In this case, the impedance Z₁₂₄ is the impedance derived by the resistance, the capacitance, and the inductance of the interconnect line 124.

In the diagrams, the term Zxxx, where xxx is a numeral, refers to the impedance of the particular interconnect line, derived from the particular electrical characteristics associated with the particular line. In the diagrams, the term Zxxxy, where xxx is a numeral, and y is a letter, refers to the impedance of the particular segment, derived from the particular electrical characteristics associated with the particular segment.

Correspondingly, the line segment 128a has an impedance Z₁₂₈ₐ, the line segment 130a has an impedance Z₁₃₀ₐ, and the line segment 134a has an impedance Z₁₃₄ₐ. In the diagrams, if the interconnect line has been divided into N segments of the full high-order segmented model, the associated impedance for the line would be denoted as Z_{xxxy}, where ₓₓₓ is the specific line and Y is the number, or letter, associated with such segment, and where Y<=N. Of course, N may be any whole number. The resistance symbol, when denoted with a Z_{xxxy} indicating, should be read as having the specific inductive, resistive, and capacitive characteristics of the specific electrical characteristics of the particular line segment.

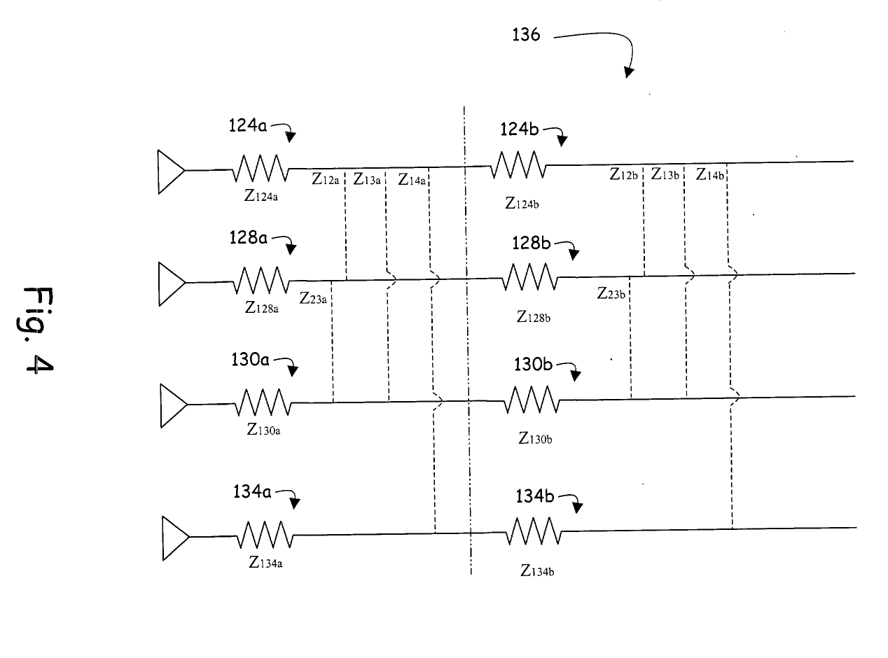

FIGS. 3 and 4 show exemplary segmentations that can be used in the use if the apparatus of FIG. 1. The model maintains the electrical relationships between the line segments, even though these relationships are not depicted in FIG. 2. In FIG. 3, the cross impedance between the line segment 124z and the line segment 128z is depicted as the impedance Z₁₂. The cross impedance between the line segment 124z and the line segment 130z is depicted as the impedance Z₁₃. The cross impedance between the line segment 124z and the line segment 134z is depicted as the impedance Z₁₄.

The full scope of the relationships are brought into the model, although not necessarily depicted in this graph. It should be noted that cross impedance term may exist for every line pair.

In this implementation, a circuit simulation program, such as a SPICE program, derives a solution for this representation of the system. In particular, the circuit simulation program can derive a very accurate solution for the representation of the system operating at high switching speed. In this case, the particular drivers are simulated in the detailed simulation. However, instead of the driver driving the higher-order simulated line made up of all the segments, all the lines using all their segments, and all the cross impedances between the segments, a lower-order model of the simulated line is used, such as the model depicted in FIG. 3.

The driver precharacterization using a circuit simulator derives a driver signal based on the representation of the system of one segment, the driver, and the electrical relationships between the segment and the other interconnect lines. Compared with the simulation run with a model having drivers coupled to the entire interconnect system made up of many coupled segments, this precharacterization step may be accomplished using significantly less resources and time.

FIG. 4 is another diagram depicting another precharacterization model using some number of the segments associated with the interconnect line, rather than just one segment of each interconnect line. In this case a model 136 is derived using two segments of each interconnect line, as well as the related cross impedances. It should be noted that the model can be extended to any number of interconnect lines, each with cross impedance terms between them.

In the figures above, the system shown may be expanded to any number of drivers and interconnect lines. The interconnect lines may be expanded to any numbers of line segments. Further, the precharacterization step may be used on a line segment of each interconnect line, or any number of line segments such that the number of line segments used in the precharacterization is smaller than that used to characterize the full high-order segmented interconnect line. In this manner, a precharacterization of the driver signal indicative of the driver output in the physical system may be obtained.

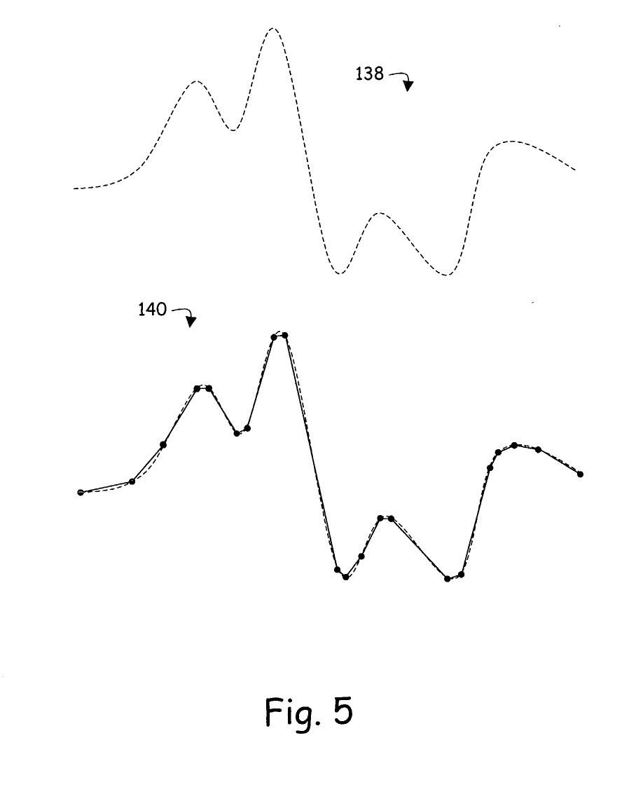

FIG. 5 is a diagram of an exemplary linearization technique of FIG. 1. The precharacterization produces a resultant signal 138. In order to effectively use the precharacterization signal in the method and apparatus described, a linearization of the signal may take place, such as that depicted as a piecewise linear signal 140. This piecewise linear signal 140 is shown superimposed over the original precharacterization signal 138.

The entire interconnect system may be reduced to a lower order solution. In this case, the lines 124, 128, and 130, and others not shown, and the cross impedance values between the various line segments, are reduced in order. This produces a reduced order model of the interconnect system. This may be accomplished using such techniques as a passive reduced-order interconnect macromodeling algorithm (PRIMA), or any other technique in which the order of the interconnect model is reduced for ease of computation. Such other techniques include asymptotic waveform evaluation, or other such types of techniques.

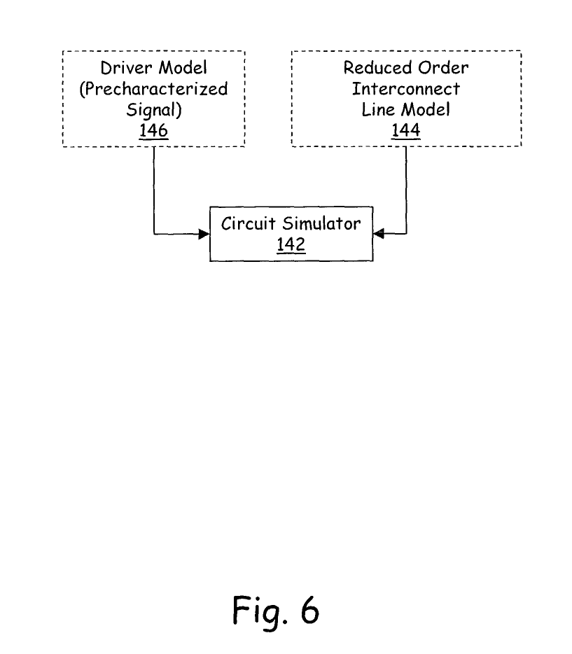

FIG. 6 is a block diagram linking the reduced order interconnect model to the linearized precharacterization signal. In this case, the inputs to a circuit simulation 142 include the reduced order model of the interconnect system 144, and the linearized precharacterization of the driver signal 146. In this manner, the driver is substituted by the linear precharacterized signal. Thus, the simulator need not simulate the operation of the non-linear driver in the reduced order model of the interconnect line system. In this manner, a rapid and accurate solution can be constructed for interconnect systems using driver precharacterization and reduced order modeling techniques. The driver itself is not simulated, but supplied as a derived signal.

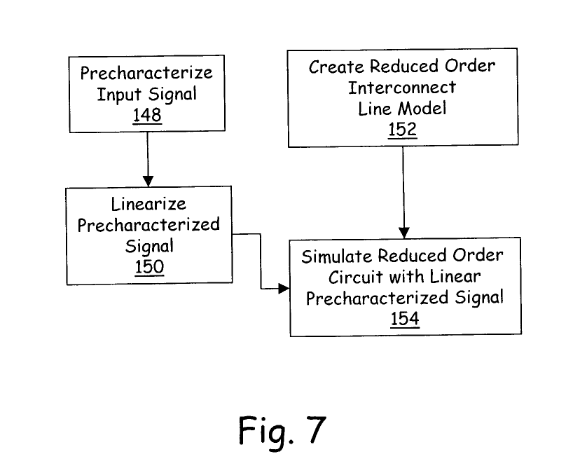

FIG. 7 is a flowchart detailing the method by which the apparatus of FIG. 1 may operate. In particular, the driver response is precharacterized in the block 148. Moreover, the precharacterization can entail the precharacterization by implementing a SPICE simulation of the various drivers using a number of segments of an interconnect line, where the various interconnect lines are modeled as a plurality of interconnect segments and the number of segments used is less than the number of segments making up the full high-order interconnect line. Of course, the segments used in the precharacterization may be one segment, or a combination of several segments.

The precharacterization signal is then linearized in a block 150. The linearization may be a piece wise linearization of the signal, where the various segments are straight-line segments. Or, the linearization may take place with higher order segments, allowing for various spline techniques.

Additionally, the entire interconnect segment system is modeled as a lower order system in a block 152. This step may take place, before, after, or in parallel with the step signified in the blocks 148 and 150. In a block 154, the linearized precharacterization signal is input into the reduced order representation of the interconnect system.

The invention may be embodied on any computing device or software that runs on a computer. The invention may run on one computer as a monolithic process, or across computers as several different processes. The process or processes may be implemented on any combination of platform and operating system. It may be embodied in any combination of software or hardware, including running instructions from any computer readable medium.

Thus, a method and apparatus for modeling circuitry is described and illustrated. Those skilled in the art will recognize that many modifications and variations of the present invention are possible without departing from the invention. Of course, the various features depicted in each of the figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

I claim:

1. A method for linearly modeling behavior of a non-linear component with a first interconnect line in a system of a plurality of interconnect lines, the method comprising:
modeling the each of the plurality of interconnect lines as a plurality of segments, each of the segments of each particular interconnect line coupled together;
modeling the non-linear component coupled to a line segment, the line segment being one of the plurality of segments of the first interconnect line;
generating a precharacterized signal associated with the first interconnect line, the signal associated with the output of the non-linear component on the line segment; and
inputting the precharacterized signal into a linearized simulation of the system of interconnect lines.

2. The method for claim 1, the step of modeling the non-linear component comprising:
modeling electrical effects of the other interconnect lines on the signal associated with the first interconnect line.

3. The method for claim 2 wherein the electrical effect is a mutual inductance.

4. The method for claim 2 wherein the electrical effect is a mutual capacitance.

5. The method for claim 1 wherein the linearized simulation is a reduced-order interconnect macromodeling algorithm.

6. The method for claim 5 wherein the reduced-order interconnect macromodeling algorithm is a PRIMA process.

7. The method for claim 1, the step of generating a precharacterized signal comprising:
deriving, with a circuit simulator, a waveform indicative of the output of the non-linear component on the line segment; and
deriving a linear model of the waveform.

8. The method for claim 7 wherein the circuit simulator is a SPICE program.

9. The method for claim 7 wherein the line segment is a combination of segments of the first interconnect line.

10. An apparatus for modeling behavior of a non-linear component with a first interconnect line in a system of a plurality of interconnect lines, the apparatus comprising:
means for modeling the first interconnect line as a one or more line segments, each of the line segments coupled together to form the first interconnect line;
means for modeling the non-linear component coupled to a line segment from the one or more line segments;
means for generating a precharacterized signal associated with the first interconnect line, the signal indicative of the output of the non-linear component coupled to the line segment; and
means for inputting the precharacterized signal into a linearized simulation of the system of interconnect lines.

11. The apparatus of claim 10, the means for modeling comprising:
means for modeling electrical effects of other interconnect lines on the first interconnect line.

12. The apparatus of claim 11 wherein the electrical effect is a mutual inductance.

13. The apparatus of claim 11 wherein the electrical effect is a mutual capacitance.

14. The apparatus of claim 10 wherein the linearized simulation is a reduced-order interconnect macromodeling algorithm.

15. The apparatus of claim 14 wherein the reduced-order interconnect macromodeling algorithm is a PRIMA process.

16. The apparatus of claim 10, the means for generating a precharacterized signal comprising:
means for deriving a waveform indicative of the output of the non-linear component coupled to the line segment; and
means for deriving a linear model of the waveform.

17. The apparatus of claim 16 wherein the means for deriving a waveform is a SPICE program.

18. The apparatus of claim 16 wherein the line segment is comprised of a plurality of the one or more line segments.

19. A program storage device readable by a machine, tangibly embodying a program of instructions readable by the machine to perform a method for modeling behavior of a non-linear component with a first interconnect line in a system of a plurality of interconnect lines, the device comprising:
instructions for making a model of the first interconnect line, the model associating the first interconnect line as a plurality of segments, each of the segments coupled together;
instructions for modeling the non-linear component coupled to the model of the first interconnect line;
instructions for generating a precharacterized signal indicative of the output of the non-linear component coupled to the model of the first interconnect line; and
instructions for inputting the signal into a linearized simulation of the system of interconnect lines.

20. The program storage device of claim 19, the instructions for modeling the first interconnect lines comprising:
instructions for modeling electrical effects of other interconnect lines on the first interconnect line.

21. The program storage device of claim 20 wherein the electrical effect is a mutual inductance.

22. The program storage device of claim 20 wherein the electrical effect is a mutual capacitance.

23. The program storage device of claim 19 wherein the linearized simulation is a reduced-order interconnect macromodeling algorithm.

24. The program storage device of claim 23 wherein the reduced-order interconnect macromodeling algorithm is a PRIMA process.

25. The program storage device of claim 19, the instructions for generating a precharacterized signal comprising:
instructions for deriving a waveform indicative of the output of the non-linear component coupled with the model of the first interconnect line; and
instructions for deriving a linear model of the waveform.

26. The program storage device of claim 25 wherein the instructions for deriving a waveform are executed with a SPICE program.

27. The program storage device of claim 25 wherein the model of the first interconnect line is a combination of a plurality of segments.

28. An apparatus for determining the behavior of a circuit model, the circuit model having a non-linear component with a first interconnect line in a system of a plurality of interconnect lines, the apparatus comprising:
a first circuit simulator, the first circuit simulator operable to:
a) determine a model of the first interconnect line as a plurality of segments, each of the segments coupled together;
b) model the non-linear component coupled to the model of the first interconnect line; and
c) derive a signal indicative of the output of the non-linear component coupled to the model of the first interconnect line;
a reduced order interconnect module, communicatively coupled to the first circuit simulator, that produces a reduced order linearized model of the system of interconnect lines; and
a second circuit simulator, communicatively coupled to the a reduced order interconnect module and to the first circuit simulator, that derives an output signal on the first interconnect line based on the linear signal produced by the first circuit simulator and the reduced order linearized model.

29. The apparatus of claim 28, the model of the interconnect lines comprising:
a model of the electrical effects of other interconnect lines on the first interconnect line.

30. The apparatus of claim 29 wherein the electrical effect is a mutual inductance.

31. The apparatus of claim 29 wherein the electrical effect is a mutual capacitance.

32. The apparatus of claim 28 wherein the reduced-order interconnect module performs a PRIMA process.

33. The apparatus of claim 28, the apparatus further comprising:
a linearization module, communicatively coupled to the first circuit simulator, that linearizes the model of the waveform.

34. The apparatus of claim 28 wherein the first circuit simulator is a SPICE program.

35. The apparatus of claim 34, wherein the second circuit simulator is a linear circuit simulator.

36. The apparatus of claim 28 wherein the second circuit simulator is a PRIMA program.

37. The apparatus of claim 28 wherein the model of the first interconnect line is a combination of a plurality of the segments associated with the first interconnect line.

38. The apparatus of claim 28, wherein the second circuit simulator is a linear circuit simulator.

39. The apparatus of claim 28, wherein the second circuit simulator produces an output of the linearized model faster than the first circuit simulator produces an output for the circuit model.

40. An apparatus for emulating a circuit having a non-linear component and an interconnect line, the apparatus comprising:
a circuit simulator that simulates non-linear components and produces an output signal representative of a signal appearing on the interconnect line;
a signal processor, communicatively coupled to the circuit simulator, that produces a linear representation of the output signal; and
a reduced order interconnect simulator, communicatively coupled to the signal processor, producing a linear signal representative of the non-linear component based on the linear representation of the output signal of the signal processor.

41. A program storage device readable by a machine, tangibly embodying a program of instructions readable by the machine to perform a method for emulating a circuit, the circuit having a non-linear component coupled to a first interconnect line within a plurality of interconnect lines, the apparatus comprising:
instructions for deriving a multi-segment model of the first interconnect line;
instructions for simulating the non-linear component and producing an output waveform representative of a signal appearing on the model of the interconnect line, the model having an electrical relationship to the others of the plurality of interconnect lines;
instructions for producing a linear representation of the output waveform; and
instructions for deriving a reduced order interconnect model of the plurality of interconnect lines;
instructions for deriving on output signal based on the introduction of the linear representation of the output waverform into the reduced order interconnect model.

42. An apparatus for emulating a circuit, the circuit having a non-linear component coupled to a first interconnect line within a plurality of interconnect lines, the apparatus comprising:
means for deriving a multi-segment model of the first interconnect line;
means for simulating the non-linear component and producing an output waveform representative of a signal appearing on the model of the interconnect line, the model of the first interconnect line having an electrical relationship to the others of the plurality of interconnect lines;
means for producing a linear representation of the output waveform; and
means for deriving a reduced order interconnect model of the plurality of interconnect lines;
means for deriving on output signal based on the introduction of the linear representation of the output waveform into the reduced order interconnect model.

43. A method for emulating a circuit, the circuit having a non-linear component coupled to a first interconnect line within a plurality of interconnect lines, the apparatus comprising:
deriving a multi-segment representation of the first interconnect line;
simulating the non-linear component and producing an output waveform representative of a signal appearing on the representation of the first interconnect line, the representation having an electrical relationship to the others of the plurality of interconnect lines;
producing a linear representation of the output waveform; and
deriving a reduced order interconnect model of the plurality of interconnect lines;
deriving on output signal based on the introduction of the linear representation of the output waveform into the reduced order interconnect model.

44. A method for emulating a circuit containing a non-linear component coupled to a first interconnect line within a plurality of interconnect lines, the first interconnect line represented by a multi-segment interconnect model, the plurality of interconnect lines reduced to a reduced order interconnect model, the method comprising:
simulating the operation of a non-linear component on a line segment associated with the first interconnect line, the first interconnect line represented as a segment of the interconnect line;
producing, based on the step of simulating, a driver signal on the first interconnect line;
deriving a linear representation of the driver signal; and
deriving an output of the driver signal introduced into the reduced order interconnect model.

45. An apparatus for determining the behavior of a circuit, the circuit having a non-linear component with a first interconnect line in a system of a plurality of interconnect lines, the apparatus comprising:
a circuit model of the system, the model comprising:
a model of the first interconnect line, the model representing the first interconnect line as a plurality of segments, each of the plurality of segments coupled together, one of the plurality of segments modeled with an electrical association to another of the plurality of interconnect lines;
a non-linear circuit simulator, communicatively coupled to the model of the first interconnect line, that derives a signal indicative of the output of the non-linear component when coupled to first interconnect line;
a reduced order interconnect module, communicatively coupled to the circuit model, that produces a reduced order linearized model of the system of interconnect lines; and
a linear circuit simulator, communicatively coupled to the a reduced order interconnect module and to the non-linear circuit simulator, that derives an output signal on the first interconnect line based on the linear signal produced by the first circuit simulator and the reduced order linearized model.
